(19) United States
(12) Patent Application Publication
(10) Pub. No.: US 2022/0109629 A1
(43) Pub. Date: Apr. 7, 2022

(54) MITIGATING SERVICE OVERRUNS

(71) Applicant: Vmware, Inc., Palo Alto, CA (US)

(72) Inventors: SHIRISH VIJAYVARGIYA, Pune (IN); Sunil Hasbe, Pune (IN)

(21) Appl. No.: 16/952,212

(22) Filed: Nov. 19, 2020

(30) Foreign Application Priority Data
Oct. 1, 2020 (IN) 202041042753

(51) Int. Cl. H04L 12/801; G06F 9/455

(52) U.S. Cl. CPC H04L 47/12; G06F 9/45558; G06F 2009/45591; G06F 2009/45587; G06F 2009/45595

(57) ABSTRACT

Embodiments of the present disclosure relate to a method for preventing a service executing on a host machine from overrunning. The method receives, by the service running on the host machine, one or more packets via a data path. The method determines that the service is in or approaching an overrun state. Upon the determining, the method identifies a set of one or more virtual computing instances (VCIs) running on the host machine, and sends, via a first path different than the data path, a set of one or more signals to the set of VCIs, the one or more signals indicating to the set of VCIs to slow down transmitting network traffic via the data path.

### RELATED APPLICATIONS

Benefit is claimed under 35 U.S.C. 119(a)-(d) to Foreign Application Serial No. 202041042753 filed in India entitled “MITIGATING SERVICE OVERRUNS”, on Oct. 1, 2020, by VMware, Inc., which is herein incorporated in its entirety by reference for all purposes.

### BACKGROUND

A software-defined datacenter includes a plurality of host machines in communication over a physical network infrastructure, each host machine having one or more virtual computing instances (VCIs), such as virtual machines (VMs), containers, etc. Similar to applications running on physical machines, applications running on VMs are susceptible to malicious attacks. Though certain embodiments are described herein with respect to VMs, it should be noted that the teachings herein may also apply to other types of VCIs.

On each host machine, a security manager may be configured to protect against malicious attacks on the VMs that run on the same host machine. For example, a security manager that protects VMs and/or applications running on the VMs may be referred to as being part of an endpoint security system. Among other tasks, the security manager of a host machine may implement a security service that enforces firewall rules that are defined based on the identity of application users, herein referred to as user-based firewall rules. In addition to the security manager, the VMs of a host machine may be protected by a distributed firewall that runs on the host machine (e.g., in the hypervisor of the host machine). A distributed firewall may enforce security policies at the internet protocol (IP) level for the VMs of the host machine. Other services may be configured for various reasons, e.g., to provide intrusion detection and prevention, load balancing, and so forth.

As the numbers of computing devices in datacenters increase, the amount of network traffic increases. Consequently, large amounts of network traffic may be forwarded to service VMs and/or distributed firewalls for security check or other services, which may result in a service overrun and causing the service to become unresponsive. For example, when the incoming packet rate surpasses the packet processing rate of a service endpoint, packets may accumulate inside the service's queue until available memory of the service becomes exhausted. As a result, the service may become unresponsive (or “unavailable”) and cannot process the network traffic anymore. This may violate the requirements of a service level agreement (SLA) that requires continuous and uninterrupted protection by the service.

### SUMMARY

Herein described are one or more embodiments of a method for preventing a service executing on a host machine from overrunning. The method comprises receiving, by the service running on the host machine, one or more packets via a data path; determining, by the service running on the host machine, that the service is in or approaching an overrun state; upon the determining, identifying a set of one or more virtual computing instances (VCIs) running on the host machine; and sending, via a first path different than the data path, a set of one or more signals to the set of VCIs, the one or more signals indicating to the set of VCIs to slow down transmitting network traffic via the data path.

Also described herein are embodiments of a non-transitory computer readable medium comprising instructions to be executed in a computer system, wherein the instructions when executed in the computer system perform the method described above for preventing a service executing on a host machine from overrunning. For example, the instructions may include code or one or more instructions for performing each step of the method.

Also described herein are embodiments of a computer system, wherein software for the computer system is programmed to execute the method described above for preventing a service executing on a host machine from overrunning. For example, the computer system may include a processor coupled to a memory configured to perform each step of the method.

Also described herein are embodiments of a computer system comprising various means for executing the various steps of the method described above for preventing a service executing on a host machine from overrunning.

Although the present description is directed towards an exemplary embodiment of protecting a firewall from being overrun, the methods, media, and systems described might be useful for any network service that might be susceptible to overrun conditions.

### BRIEF DESCRIPTION OF THE DRAWINGS

FIG. 1 is a block diagram depicting physical and virtual components of a networking environment, in which one or more embodiments of the present disclosure may be implemented.

FIG. 2 is a block diagram illustrating data communication between the VCIs and a security VCI within a host machine, according to an example embodiment of the present application.

FIG. 3 is a block diagram illustrating signal communication between the VCIs and a security VCI within a host machine, according to an example embodiment of the present application.

FIG. 4 is a flowchart illustrating an example process/method for preventing a firewall from overrunning, according to an example embodiment of the present application.

FIG. 5 is a flowchart illustrating another example process/method for preventing a firewall from overrunning, according to an example embodiment of the present application.

FIG. 6 is a flowchart illustrating an example process/method for delaying packet transmission in a VCI, according to an example embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

As described, a firewall (e.g., implemented as a security VCI or a distributed firewall) may exhaust its resources and enter an overrun state when, for example, packet incoming rate of the firewall surpasses its packet processing rate. Accordingly, some embodiments provide an efficient mechanism for mitigating firewall overruns by preventing (e.g., bursty) VCIs from forwarding heavy traffic to a firewall when the firewall is near the exhaustion of (or has already exhausted) its resources. For example, a firewall may monitor its resources (e.g., memory utilization, packet incoming queue, etc.) to determine whether any of its resource usages is reaching a critical threshold. In some embodiments, when the firewall determines that its resource usage(s) is approaching, or has reached, the critical threshold, the firewall may send one or more signals to one or more VCIs, such as one or more VCIs that the firewall has determined to be bursty or hyperactive. The signals may cause the VCIs to slow down their outgoing traffic, which may result in less traffic being sent to the firewall.

In some embodiments, when a firewall of a host machine determines that it is approaching its resource usage limit (or it is in an overrun state), the firewall may send a signal to a traffic control manager residing in the hypervisor of the host machine. Along with the signal, the firewall may send identifying information (e.g., IP addresses) of one or more VCIs to the traffic control manager. It should be noted that the one or more VCIs, in some embodiments, are the VCIs that have an outgoing traffic transmission rate/size greater than a threshold rate/size. In some embodiments a packet transmission rate for a VCI is a number of packets received by the firewall from the VCI over a time period/time window. In some embodiments, the packet transmission rate may be calculated as a moving average. In some embodiments, a packet size for a VCI may be a total size (e.g., in bytes) of all the packets received by the firewall from the VCI over a time period/time window. In some embodiments, the packet size may be calculated as a moving average.

In some embodiments, the firewall may keep track of packet transmission rates and/or sizes of the VCIs from which the firewall receives traffic (e.g., to inspect). In some such embodiments, when the firewall determines that it is about to overrun (or already in an overrun state), the firewall may identify the one or more VCI(s) and send corresponding identifying information along with the overrun signal to the traffic control manager in the hypervisor. A network admin may set a high threshold value for the firewall that indicates the firewall is approaching the overrun state, and a low threshold value that indicates the firewall is approaching a normal state of operations. In some such embodiments, when the firewall determines that its usage of resources (e.g., memory utilization usage) is on, or has passed, the high threshold value, the firewall may send the overrun signal(s) to the traffic control manager.

After the traffic control manager receives the overrun signal from the firewall (along with the information identifying the VCIs that should be slowed down), the traffic control manager may send one or more signals to a traffic control agent residing in each of the identified VCIs. The traffic control agent in each VCI may reside between the application(s) that generate the outgoing traffic and the outgoing port(s) (e.g., of a virtual network interface controller/card (VNIC)) of the VCI. As such, in some embodiments, a traffic control agent may slow down the traffic it receives from the application(s) upon receiving an overrun signal from the traffic control manager of the host machine. In some embodiments, the traffic control agent may intercept one or more handshake packets initiated by an application of the VCI (e.g., to connect to other application(s) running on other VCI(s)) before those packets reach the outgoing port. To introduce delay in the outgoing traffic, the traffic control agent may hold the handshake packets for a certain amount of time (e.g., for a few milliseconds, but less than a timeout limit defined by the transmission protocol in some embodiments) before releasing the handshake packets to be sent out via the outgoing port.

In some embodiments, after the incoming traffic to an overrun firewall subsides (e.g., as a result of delaying the outgoing traffic of the bursty VCIs) and the firewall returns to a normal state of operation, the firewall may send one or more signals to the (previously identified as) VCIs to return to normal packet transmission rate. For example, the firewall may send a signal to the traffic control manager indicating that the firewall is not in the overrun state anymore. In some embodiments, when the firewall determines that its usage of resources (e.g., packet incoming queue) is on, or has passed, the low threshold value (as described above), the firewall may send the normal state signal(s) to the traffic control manager. Upon receiving this signal, the traffic control manager may send one or more signals to the traffic control agents of the (previously identified) VCIs. Each traffic control agent may, in turn, stop delaying the outgoing traffic of its corresponding VCI (e.g., by not intercepting the handshake packets) and enter a hibernate state (e.g., listening for another overrun signal to be received from the traffic control manager of the host machine).

In some embodiments, the path for exchanging firewall overrun signals may be different than a data path through which the network traffic is transmitted (e.g., exchanged between the applications running on the VCIs). For example, in some embodiments, a multiplexer (MUX) residing in the hypervisor of the host machine may exchange the firewall overrun signals between the firewall and the traffic control manager, and between the traffic control manager and the traffic control agents of the VCIs. This way, the firewall overrun signals are not placed on incoming and/or outgoing queues of different ports of the forwarding elements of a data path, which may cause undesired delays in the transmission of these signals.

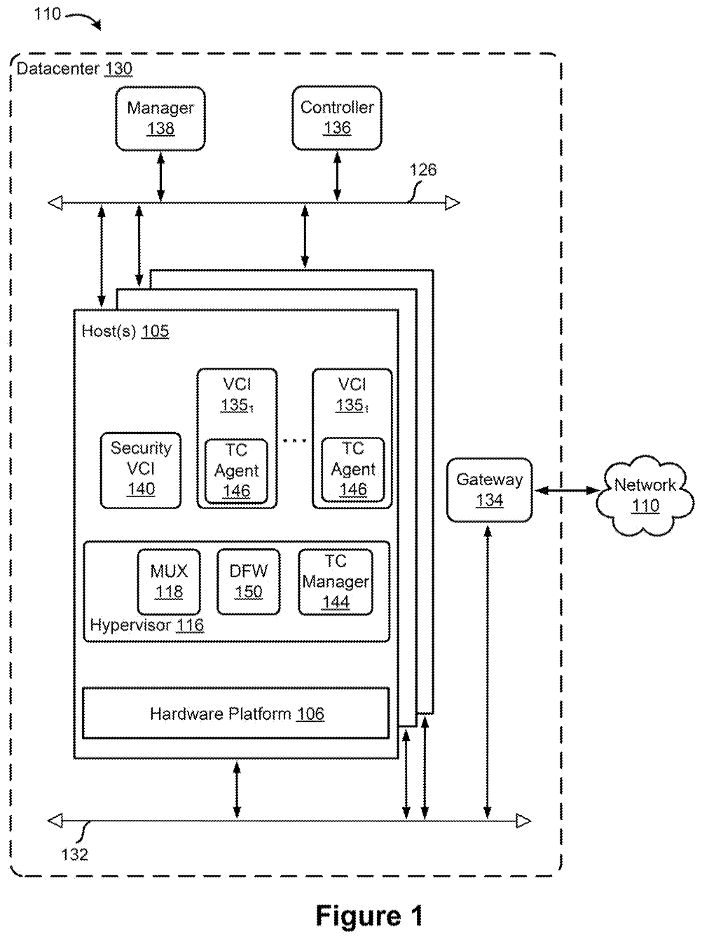

FIG. 1 is a block diagram depicting physical and virtual components of a networking environment, in which one or more embodiments of the present disclosure may be implemented. Computer system 110 includes a datacenter 130 connected to a network 110. Network 110 may be, for example, a direct link, a local area network (LAN), a wide area network (WAN), such as the Internet, another type of network, or a combination of these networks.

Datacenter 130 includes host(s) 105, a gateway 134, a management network 126, and a data network 132. Datacenter 130 also includes a controller 136 and a manager 138 connected to management network 126. Controller 136 may be a computer program that resides and executes in a central server in datacenter 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of datacenter 130. Controller 136 communicates with hosts 105 via management network 126.

Manager 138 generally represents a management plane comprising one or more computing devices responsible for receiving logical network configuration inputs, such as from a network administrator, defining one or more endpoints (e.g., VMs and/or containers) and the connections between the endpoints, as well as rules governing communications between various endpoints. For example, manager 138 may receive security (or firewall) policies from a network administrator, and may send the security policies as network configuration data to controller 136 for distribution to endpoints on hosts 105 via management network 126. For example, controller 136 may distribute the security policies as network configuration to security VCI 140 and distributed firewall 150 residing in each host 105.

Controller 136 and manager 138 may be integrated into a single appliance, be distributed across hosts 105, or be part of a centralized management and control system (not shown in the figure) that includes one or more controllers and managers. The centralized management and control system may carry out administrative tasks for datacenter 130. The administrative tasks may include, but are not limited to, managing hosts 105, managing workload VCIs 135 (e.g., VMs and/or containers) running within each host 105, defining network topologies, provisioning VMs, migrating VMs from one host to another host, load balancing between hosts 105, etc.

The centralized management and control system may also create and maintain one or more logical network overlays implemented (e.g., by the hypervisors 116 of the host machines) on the underlay physical network (e.g., data network 132). Both management and user networks 126 and 132, as well as the overlay logical networks may include multiple forwarding elements (e.g., routers, switches, middle boxes, etc.) that are connected to each other to create different network paths carrying different flows of the network. The different flows may include, but are not limited to, data flows exchanged between the hosts of datacenter 130, data flows exchanged between the hosts of datacenter 130 and other computing systems, such as hosts of other datacenters (e.g., through network 110), management and control flows exchanged between the hosts of datacenter 130 and centralized management and control system of datacenter 130, etc.

As will be described in more detail below, security VCI 140, which may be an instance of a service virtual machine (SVM), and/or distributed firewall (DFW) 150, may receive packets of the data flows in order to enforce policy rules (e.g., firewall rules) defined by the datacenter admins (and by clients of the overlay networks). In some embodiments, DFW 150 may enforce the policy rules at IP level, while security VCI 140 may enforce user- or identity-based (“ID-based”) security rules. In some embodiments, each of security VCI 140 and DFW 150 may be capable of independently or cooperatively enforcing both or either of IP-based and ID-based security rules. As shown, in some embodiments, security VCI 140 may be implemented as an individual VCI executing on each host machine 105. DFW 150 may be a module residing in hypervisor 116 of each host machine 105 in some embodiments.

It should be noted that even though certain embodiments described hereinafter use security VCI 140 as an example firewall, same descriptions may equally apply to distributed firewall 150, and distributed firewalls should be considered as being within the scope of the disclosure of the embodiments herein.

As a result of receiving the above described flows from different sources, security VCI 140 may overrun or may critically approach the overrun state. That is, for example, when the incoming traffic rate for security VCI 140 is greater than the packet processing rate of the security VCI, packets may accumulate on the packet incoming queue of security VCI 140 and all available memory of the firewall may be exhausted. To prevent a firewall overrun, security VCI 140 may identify the sources (e.g., VCIs) that are creating more traffic than the other sources. Security VCI 140 may then send one or more signals to traffic control (TC) manager 144. TC manager 144 may be a module executing in hypervisor of each host machine 105. The signal(s) may include information about one or more VCI(s) (e.g., bursty VCIs that are generating more than a threshold amount of traffic). Though certain embodiments are described with respect to the one or more VCI(s) being bursty VCIs for ease of illustration, it should be noted that such embodiments may similarly apply to signaling of any one or more VCIs (e.g., selected at random, according to other criteria, etc.).

Upon receiving the signal(s), TC manager 144 may send one or more firewall overrun signals to TC agent 146 residing in each bursty VCI that runs on host machine 105. TC agents 146 may in turn slow down the outgoing traffic of their corresponding VCIs, as will be described in more detail below. In some embodiments, communications between Security VCI 140, TC manager 144, and TC agents 146 of bursty VCIs may be through a multiplexer (MUX) 118. That is, instead of going through virtual network devices (e.g., virtual ports of virtual forwarding elements) of a data path, through which the data flows are communicated, firewall overrun signals may be communicated through MUX 118 to prevent delay in overrun signal communications.

Datacenter 130 may include additional components (e.g., a distributed data storage, etc.) that are not shown in the figure. Networks 126, 132, in one embodiment, may each provide Layer 2 or Layer 3 connectivity in accordance with the Open Systems Interconnection (OSI) model, with internal physical or software defined switches and routers not being shown. Although the management and data network are shown as separate physical networks, it is also possible in some implementations to logically isolate the management network from the data network (e.g., by using different VLAN identifiers) in a shared physical network.

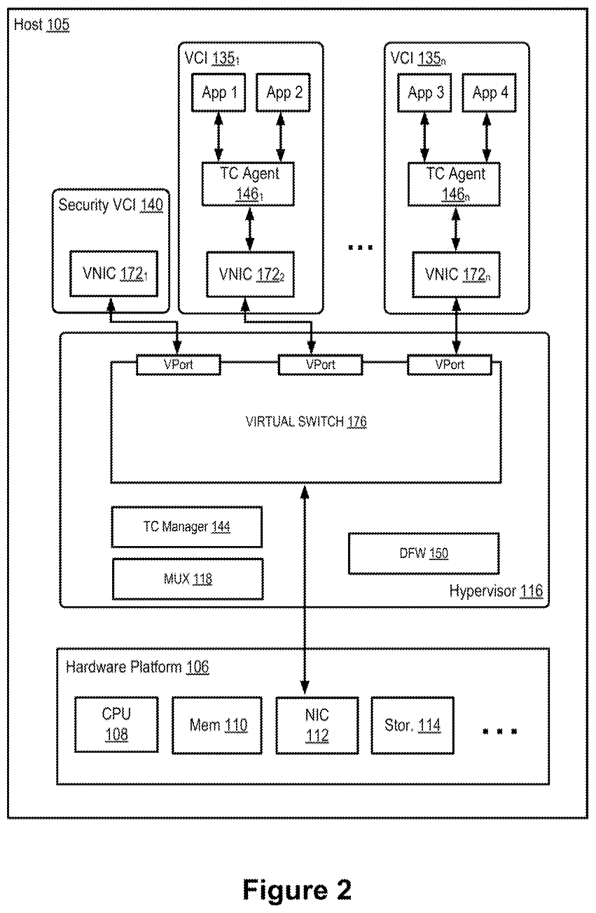

Each of hosts 105 may be constructed on a server grade hardware platform 106, such as an x86 architecture platform. For example, hosts 105 may be geographically co-located servers on the same rack or on different racks. Hardware platform 106 of each host 105, as described below, with reference to FIG. 2, may include components of a computing device, such as one or more central processing units (CPUs), system memory, network interface(s), storage system, etc.

Host 105 may be configured to provide a virtualization layer, also referred to as a hypervisor 116, that abstracts processor, memory, storage, and networking resources of hardware platform 106 into multiple workload virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like. Hypervisor 116 may run on top of the operating system in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines.

In some implementations, the hypervisor may comprise system level software as well as a “Domain 0” or “Root Partition” virtual machine (not shown) which is a privileged virtual machine that has access to the physical hardware resources of the host and interfaces directly with physical I/O devices using device drivers that reside in the privileged virtual machine. VCI 135 may include VMs, containers, Docker containers, data compute nodes, isolated user space instances, namespace containers, and the like. Though certain aspects may be described with respect to a VM, they may similarly be applicable to other VCIs and/or physical endpoints.

Although hosts 105 are shown as including a hypervisor 116 and VCIs 135, in an embodiment, hosts 105 may include a standard operating system instead of a hypervisor 116, and hosts 105 may not include VCIs 135.

Gateway 134 provides hosts 105, VCIs 135, and other components in datacenter 130 with connectivity to one or more networks, such as network 110, used to communicate with one or more remote datacenters or other entities. Gateway 134 may manage external public Internet Protocol (IP) addresses for VCIs 135 and route traffic incoming to and outgoing from datacenter 130 and provide networking services, such as firewalls, network address translation (NAT), dynamic host configuration protocol (DHCP), and load balancing. Gateway 134 may use data network 132 to transmit data network packets to hosts 105. Gateway 134 may be a virtual appliance, a physical device, or a software module running within host 105.

FIG. 2 is a block diagram illustrating data communication between the workload VCIs 135 and a security VCI 140 within one of the host machines 105 (as shown in FIG. 1), according to an example embodiment of the present application. As illustrated, host machine 105 may include a hypervisor 116, a hardware platform 106, a security VCI 140, and a plurality of workload VCIs 135. Hardware platform 106 of each host 105 may include components of a computing device, such as one or more central processing units (CPUs) 108, system memory 110, a network interface 112, storage system 114, and other I/O devices, such as, for example, USB interfaces (not shown). Network interface 112 enables each host 105 to communicate with other devices via a communication medium, such as data network 132 or management network 126. Network interface 112 may include one or more network ports, which may be implemented by network devices that may be referred to as network adapters or network interface cards (NICs). As described above with reference to FIG. 1, in some embodiments, data network 132 and management network 126 may be different physical networks as shown, and the hosts 105 may be connected to each of the data network 132 and management network 126 via separate NICs or separate ports on the same NIC.

Host machine 105 may provide part of the computing infrastructure in a virtualized computing environment distributed among multiple host machines. Though certain embodiments are described herein with respect to VCIs, the same principals and techniques may also apply to other appropriate virtual computing instances. In certain embodiments, host machine 105 may be a hardware computing platform (e.g., a server) or a cluster of hardware computing platforms. Each hardware computing platform includes one or more central processing units (CPUs), system memory, storage, and one or more network interfaces for communicating with other hardware computing platforms within host machine 105 and/or network destinations outside of host machine 105.

Hypervisor 116 may serve as an interface between workload VCIs 135 and security VCI 140 and physical network interface NIC 112, as well as other physical resources available on host machine 105 (e.g., resources with hardware platform 106). Security VCI 140 (along with DFW 150) is responsible for enforcing security rules on data flows communicated to/from workload VCIs 135 on host 105 to protect these VCIs. In order to receive the data flows from VCIs 135, security VCI 140 may utilize virtual NIC (VNIC) 172₁ that is logically connected to a virtual port (VPort) of virtual switch 176.

Each workload VCI 135 may also include a software network interface such as VNIC 172, which is responsible for exchanging packets (e.g., of the data flows) between the VCI 135 and virtual switch 176 implemented by hypervisor 116 by way of a virtual port (“VPort”) of virtual switch 176. Each of VNICs 172 may be, in some embodiments, a software abstraction of a physical network interface card implemented by an emulator. Each VCI 135 may be connected to a VPort provided of virtual switch 176, and the virtual switch may be connected to physical network(s) through NIC 112 to allow network traffic to be exchanged between VCIs 135 executing on host machine 105 and external network destinations (e.g., other VCIs running on other host machines 105 of datacenter 130 or other network devices within or outside datacenter 130). DFW 150 may apply a firewall filter at each VPort of virtual switch 176 for identifying relevant firewall rules and applying the relevant firewall rules for filtering packets. While hypervisor 176 is illustrated as including virtual switch 176, it should be recognized that hypervisor 116 may additionally expose virtual ports to one or more VCIs 135 or other types of VCIs using a virtual router or other virtual (or logical) forwarding elements provided by hypervisor 116.

Each VCI 135 may host one or more applications (e.g., App 1 and App 2 executing on VCI 135₁, and App 3 and App 4 executing on VCI 135ₙ) which may be used by one or more users to generate network traffic and transmit the network traffic to destinations inside or outside the computing environment of which host machine 105 is a member. The VCIs 135 communicate with each other and destinations outside of the computing environment via connections provided by the infrastructure components. When VCIs 135 are deployed, they may be deployed from a template that is specified in their respective configuration files.

As illustrated, each VCI 135 may include a traffic (or flow) control agent 146 executing on the virtual machine. TC agent 146 may be a driver, a thin client application, or daemon that resides between the applications running on the VCI and VNIC 172 of the VCI. TC agent 146 may be a hidden part of the VCI and not accessible to any other application or module running on the VCI (e.g., even to the guest OS of the VCI), while it may have access to every resource of the VCI. In some embodiments, TC agent 146 may be instantiated at runtime (e.g., when a VCI 135 is booted up) and stay in hibernate (or idle) mode waiting to receive signals from TC manager 144. TC agents 146 may be responsible for slowing down traffic generated by applications running on their respective VCIs when they receive firewall overrun signals from security VCI 140, for example, through TC manager 144 running in hypervisor 116.

As an example, when App 1 executing on VCI 135₁ communicates with App 3 executing on VCI 135ₙ (e.g., through a data path that includes VNIC 172₂, VPorts of virtual switch 176, and VNIC 172ₙ), packets of the data flow initiated by App 1 may be first sent to security VCI 140 for inspection. Other data communications between the same or other applications of the same or different VCIs (e.g., through the same or other data paths) may also be forwarded to security VCI 140 for enforcing security policies.

Security VCI 140 may monitor (e.g., periodically) its resources to determine whether it is approaching (or within) an overrun state, as a result of receiving all of the network traffic communicated between the different applications. For example, security VCI 140 may monitor its memory utilization, packet processing rate, packet incoming rate, packet pending queue, etc., to determine whether one or more of these resources are approaching a threshold point which may cause the security VCI to overrun. Security VCI 140 may also maintain a traffic profile for each VCI 135 by monitoring the traffic that each VCI 135 is generating (e.g., identified by a source address in the packets of traffic) to determine whether any of the VCIs is passing a threshold outgoing traffic rate or size. For example, Security VCI 140 may keep track of packet transmission rate and packet size transmitted by each VCI in some embodiments and multiply average packet size by average packet transmission rate to determine which VCI sends more traffic out and whether the transmitted traffic has passed a threshold.

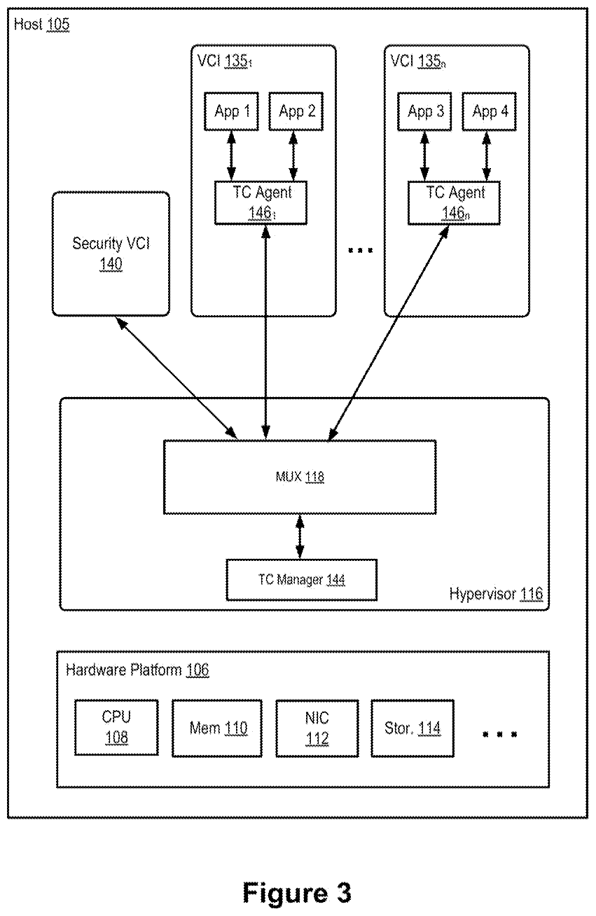

When security VCI 140 determines that it is approaching, or in, the overrun state (e.g., by monitoring its resource usages), the security VCI may send firewall overrun signals to bursty VCIs to slow down their outgoing traffic. FIG. 3 is a block diagram illustrating firewall overrun signal communication between the VCIs and a security VCI within a host machine, according to an example embodiment of the present application. Similar to FIG. 2, FIG. 3 includes Security VCI 140, multiple VCIs 135, hardware platform 106, and hypervisor 116. Unlike FIG. 2, however, FIG. 3 illustrates that firewall overrun signal communications between the different elements shown in the figure are performed through MUX 118 (instead of data paths that include virtual ports of virtual/logical forwarding elements, through which data flows are communicated).

For example, upon determining that security VCI 140 is in the overrun state, the security VCI may identify VCI 135₁ as a bursty VCI that is generating a lot of traffic (e.g., more than a defined threshold). As such, security VCI 140 may send a signal to TC manager 144 through MUX 118 indicating that VCI 135₁ should be slowed down. After receiving the signal, TC manager 118 may send one or more signals (e.g., through MUX 118) to TC agent 146₁ letting the agent know that its corresponding VCI should have its traffic throttled (e.g., it is generating more than usual traffic for security VCI 140). When TC agent 146₁ receives the signals, the traffic control agent may delay the outgoing data initiated by one or both applications App 1 and App 2 running on VCI 135₁. That is, a TC agent that resides in a VCI may slow down the outgoing traffic of the VCI irrespective of what application running on the VCI is causing a bursty traffic. For delaying the outgoing traffic, TC agent 146₁ of some embodiments may intercept one or more handshake packets initiated by the applications (e.g., to connect to other application(s) running on other VCIs) before those packets reach the outgoing port of the VCI (e.g., VNIC 172₂, with reference to FIG. 2). In some such embodiments, TC agent 146₁ may hold the handshake packets for a threshold amount of time (e.g., for a few milliseconds, but less than a timeout limit defined by the transmission protocol in some embodiments) before releasing the handshake packets to be sent out via the outgoing port. In certain aspects, delaying handshake packets may be particularly useful because the delay of a handshake further delays the generation of additional data packets by the application. Accordingly, TC agent 146₁ then does not need to buffer a large number of data packets to delay them, thereby saving on memory usage for the delay process.

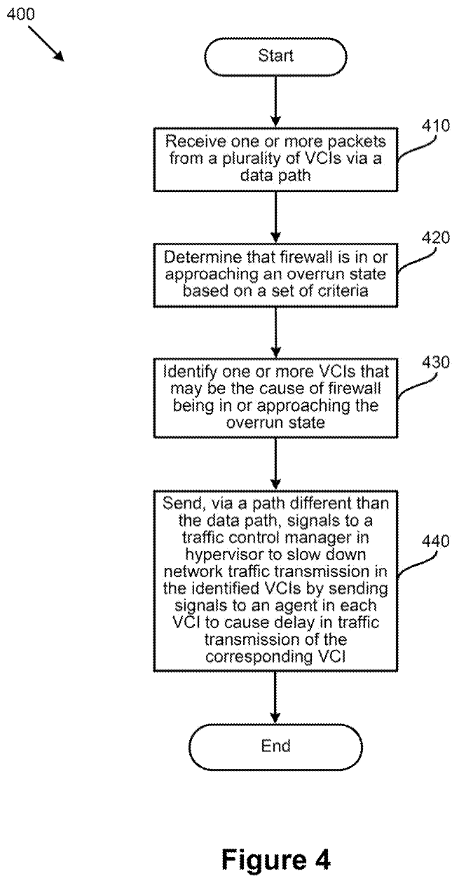

FIG. 4 is a flowchart illustrating an example process/method 400 for preventing a firewall from overrunning, according to an example embodiment of the present application. Process 400 may be performed by a firewall, such as security VCI 140 described above, with reference to FIGS. 1-3 in some embodiments. In some other embodiments, the method may be performed by some other types of firewalls, such as DFW 150 or any other virtual and/or physical device that enforces security policies.

Process 400 may start, at 410, by receiving one or more packets from a plurality of VCIs via a data path. As described above, security VCI 140 may receive several different packets from different VCIs via a data path (e.g., including one or more virtual forwarding element of a logical network) for inspection. At 420, process 400 may determine that the firewall is in, or approaching, an overrun state based on a set of criteria. As described, the set of criteria may include usage of one or more resources of the firewall, such as memory utilization, packet processing rate, packet incoming rate, packet pending queue, etc. For example, process 400 may monitor incoming packet pending queue to determine whether size of the queue has not passed a certain threshold. As another example, process 400 may determine a ratio between packet processing rate and packet incoming rate has not passed a threshold.

After determining that the firewall is in, or close to, the overrun state, process 400 may identify, at 430, one or more VCIs (e.g., that are residing on the same host machine as the firewall and may be the cause of firewall being in the current state). As such, process 400 may transmit, at 440, via a path that is different than the data path, signals to a traffic control manager (e.g., TC manager 144 shown in FIGS. 2 and 3) in hypervisor to slow down the network traffic transmission in the identified VCIs. As described, after receiving the signals, the traffic control manager may transmit one or more signals to each traffic control agent (e.g., TC agent 144 shown in FIGS. 2 and 3) in each identified VCI to cause delay in traffic transmission of the corresponding VCI. The process may then end.

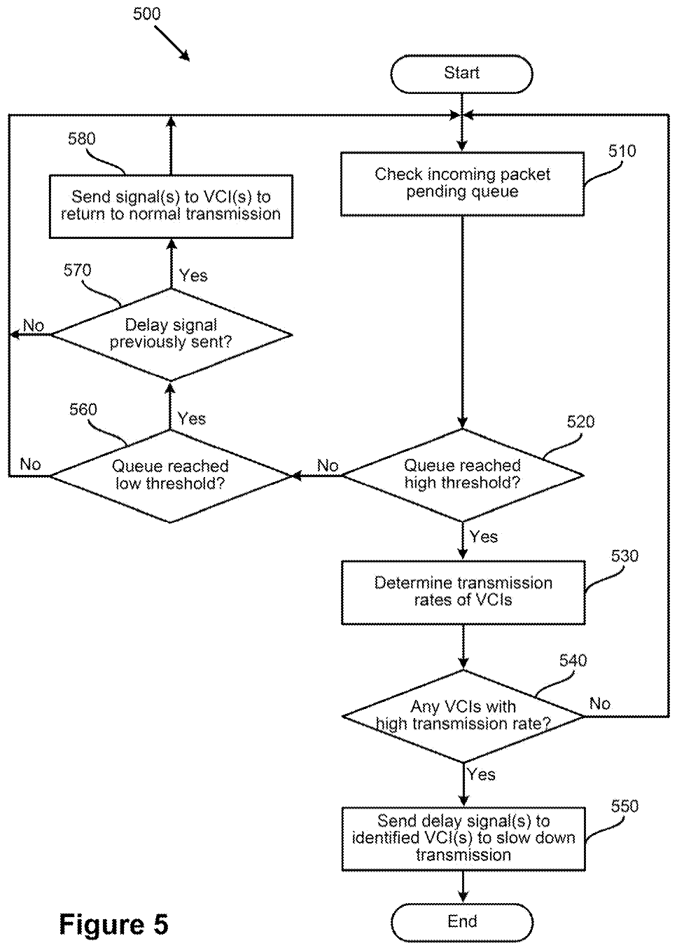

The specific operations of process 400 may not be performed in the exact order shown and described. Additionally, the specific operations may not be performed in one continuous series of operations, and different specific operations may be performed in different embodiments. For example, FIG. 5 below describes in more detail the operations performed by a firewall to prevent failing or becoming unresponsive due to an overrun.

FIG. 5 is a flowchart illustrating another example process/method 500 for preventing a firewall from overrunning, according to an example embodiment of the present application. Similar to process 400, process 500 may be performed by a firewall, such as security VCI 140 described above, with reference to FIGS. 1-3 in some embodiments. In some other embodiments, the method may be performed by some other types of firewalls, such as DFW 150 or any other virtual and/or physical device that enforces security policies.

Process 500 may start by checking, at 510, a packet pending queue to determine whether the firewall is in an overrun state. It should be noted that packet pending queue is one example criterion out of many criteria (e.g., memory utilization, packet processing rate, packet incoming rate, etc.) that process 500 may check one or more of to make such determination. At 520, process 500 may determine whether the size of packet pending queue has reached a high threshold value. As described, a network administrator may set a high threshold value for the pending queue that indicates the firewall is approaching the overrun state, and a low threshold value that indicates the firewall is approaching a normal state of operations.

When process 500 determines (at 520) that the size of the queue has not passed the high threshold value, the process may proceed to 560 which will be described below. On the other hand, if process 500 determines that the size of the queue has passed the high threshold value, the process may determine transmission rates of the VCIs to see if any of the VCIs is sending out traffic with a higher rate or size than a threshold rate/size. As described, to do this, the firewall of some embodiments may maintain a traffic transmission profile for each VCI that forwards traffic to the firewall.

Process 500 may then determine, at 540, whether any of the VCIs is transmitting traffic with a higher rate/size than a defined threshold. When the process determines that none of the VCIs is a bursty VCI, process 500 may return to 510 to check the incoming packet pending queue again. However, when process 500 determines that one or more VCIs are transmitting traffic at a rate/size higher than a threshold rate/size, the process may send one or more delay (or firewall overrun) signals to the bursty VCIs (e.g., through a traffic control manager of the hypervisor) to slow down their packet transmissions. The process may then end.

As described above, when process determines, at 520, that the size of the packet pending queue has not passed the high threshold value, the process may proceed to 560. At 560, the process may determine whether the size of the packet pending queue is lower than the low threshold value. As discussed, a low threshold value may indicate that the firewall is approaching, or in, a normal state of operations. When the process determines that the size of the packet pending queue is not lower than the low threshold value, the process may proceed to 510 to check on the size of the queue again. However, when process 500 determines that the size of the packet pending queue is now lower than the low threshold value, the process may determine, at 570, whether any delay signals have been sent (e.g., at 550) to any of the VCIs before that have put the VCIs in a slow transmission mode.

If the process determines that no delay signal has been sent to a VCI, the process may proceed to 510 which is described above. On the other hand, if process 500 determines that one or more VCIs have been previously signaled to slow down, the process may send, at 580, return to normal signals to traffic control agents of those VCIs to stop delaying packet transmissions in the VCIs.

The specific operations of process 500 may not be performed in the exact order shown and described. Additionally, the specific operations may not be performed in one continuous series of operations, and different specific operations may be performed in different embodiments. For example, process 500 may still send, at 550, delay signals to one or more VCIs that have a higher rate of outgoing traffic even though their rate may not surpass the threshold transmission rate. That is, at 540, the process may determine that none of the VCIs' transmission rates passes a certain threshold rate, but because the firewall is in a distressed state (e.g., because of high volume of incoming traffic), process may identify the VCIs that have a higher rate of transmission compared to other VCIs and may send the delay signals to those VCI to help easing down the pressure on the firewall.

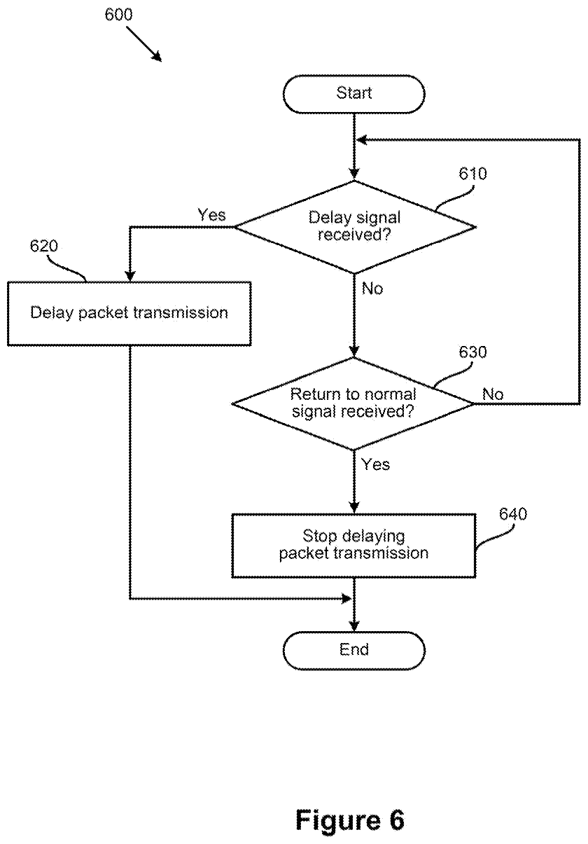

FIG. 6 is a flowchart illustrating an example process/method 600 for delaying packet transmission in a VCI, according to an example embodiment of the present application. Process 600 may be performed by a traffic control agent, such as TC agent 146 described above, with reference to FIGS. 1-3 in some embodiments.

Process 600 may start by determining, at 610, whether any delay signal has been received, for example, from a traffic control manager. If process 600 determines that a delay signal is received, the process may introduce, at 620, delay in packet transmission of the VCI in which the process is running as described above. The process may then end. However, if process 600 determines that a delay signal has not been received from the traffic control manager, the process may determine, at 630, whether any return to normal signal has been received (e.g., from the traffic control manager).

When process 600 determines that no return to normal signal has been received from the traffic control manager, the process may return to 610, for example to an idle mode, and wait for receiving a signal (e.g., a delay signal) from the traffic control manager. On the other hand, if process 600 determines that a return to normal signal has been received from the traffic control manager, the process may stop, at 640, delaying packet/flow transmission in the VCI the process is executing. To do this, as described above, the process may stop intercepting any packet that is initiated by any of the applications of the VCI. The process may then end.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory, persistent memory, solid state disk (e.g., a flash memory device), NVMe device, a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for preventing a service executing on a host machine from overrunning, comprising:
receiving, by the service running on the host machine, one or more packets via a data path;
determining, by the service running on the host machine, that the service is in or approaching an overrun state;
upon the determining, identifying a set of one or more virtual computing instances (VCIs) running on the host machine; and
sending, via a first path different than the data path, a set of one or more signals to the set of VCIs, the one or more signals indicating to the set of VCIs to slow down transmitting network traffic via the data path.

2. The method of claim 1, further comprising, after sending the one or more signals:
determining that the service is not in or not approaching the overrun state; and
upon the determining, sending, via the first path, a second set of one or more signals to the set of VCIs, the second set of signals indicating to the set of VCIs to stop slowing down transmitting the network traffic.

3. The method of claim 1, wherein the determining is based on at least one of memory utilization, packet processing rate, packet incoming rate, or packet pending queue of the service passing a threshold.

4. The method of claim 1, wherein identifying the set of VCIs is based on at least one of an average packet size and an average outgoing packet rate of each VCI in the set of VCIs.

5. The method of claim 1, wherein sending the set of signals via the first path comprises sending the set of signals to a multiplexer in communication with (i) a traffic control agent running in each VCI in the set of VCIs and (ii) a traffic control manager running in a hypervisor of the host machine, wherein the traffic control manager receives the signals from the service and sends the signals to the traffic control agent in each VCI of the set of VCIs.

6. The method of claim 5, wherein the traffic control agent of each VCI, upon receiving the set of signals, delays transmission of one or more packets initiated by an application executing on the VCI.

7. The method of claim 6, wherein the one or more packets initiated by the application comprise handshake packets for establishing a connection between the application executing on the VCI and another application executing on another VCI.

8. The method of claim 1, wherein the service comprises a firewall executing on the host machine.

9. A non-transitory computer readable medium comprising instructions to be executed in a computer system, wherein the instructions when executed in the computer system perform a method for preventing a service executing on a host machine from overrunning, the method comprising:
receiving, by the service running on the host machine, one or more packets via a data path;
determining, by the service running on the host machine, that the service is in or approaching an overrun state;
upon the determining, identifying a set of one or more virtual computing instances (VCIs) running on the host machine; and
sending, via a first path different than the data path, a set of one or more signals to the set of VCIs, the one or more signals indicating to the set of VCIs to slow down transmitting network traffic via the data path.

10. The non-transitory computer readable medium of claim 9, the method further comprising, after sending the one or more signals:
determining that the service is not in or not approaching the overrun state; and
upon the determining, sending, via the first path, a second set of one or more signals to the set of VCIs, the second set of signals indicating to the set of VCIs to stop slowing down transmitting the network traffic.

11. The non-transitory computer readable medium of claim 9, wherein the determining is based on at least one of memory utilization, packet processing rate, packet incoming rate, or packet pending queue of the service passing a threshold.

12. The non-transitory computer readable medium of claim 9, wherein identifying the set of VCIs is based on at least one of an average packet size and an average outgoing packet rate of each VCI in the set of VCIs.

13. The non-transitory computer readable medium of claim 9, wherein sending the set of signals via the first path comprises sending the set of signals to a multiplexer in communication with (i) a traffic control agent running in each VCI in the set of VCIs and (ii) a traffic control manager running in a hypervisor of the host machine, wherein the traffic control manager receives the signals from the service and sends the signals to the traffic control agent in each VCI of the set of VCIs.

14. The non-transitory computer readable medium of claim 13, wherein the traffic control agent of each VCI, upon receiving the set of signals, delays transmission of one or more packets initiated by an application executing on the VCI.

15. The non-transitory computer readable medium of claim 9, wherein the service comprises a firewall executing on the host machine.

16. A system comprising one or more processors and a non-transitory computer readable medium comprising instructions that, when executed by the one or more processors, cause the one or more processors to perform a method for preventing a service executing on a host machine from overrunning, the method comprising:
receiving, by the service running on the host machine, one or more packets via a data path;
determining, by the service running on the host machine, that the service is in or approaching an overrun state;
upon the determining, identifying a set of one or more virtual computing instances (VCIs) running on the host machine; and
sending, via a first path different than the data path, a set of one or more signals to the set of VCIs, the one or more signals indicating to the set of VCIs to slow down transmitting network traffic via the data path.

17. The system of claim 16, the method further comprising, after sending the one or more signals:
determining that the service is not in or not approaching the overrun state; and
upon the determining, sending, via the first path, a second set of one or more signals to the set of VCIs, the second set of signals indicating to the set of VCIs to stop slowing down transmitting the network traffic.

18. The system of claim 16, wherein the determining is based on at least one of memory utilization, packet processing rate, packet incoming rate, or packet pending queue of the service passing a threshold.

19. The system of claim 16, wherein identifying the set of VCIs is based on at least one of an average packet size and an average outgoing packet rate of each VCI in the set of VCIs.

20. The system of claim 16, wherein sending the set of signals via the first path comprises sending the set of signals to a multiplexer in communication with (i) a traffic control agent running in each VCI in the set of VCIs and (ii) a traffic control manager running in a hypervisor of the host machine, wherein the traffic control manager receives the signals from the service and sends the signals to the traffic control agent in each VCI of the set of VCIs.
